(19) United States
(12) Patent Application Publication
(10) Pub. No.: US 2007/0245006 A1
(43) Pub. Date: Oct. 18, 2007

(54) Apparatus, method and computer program product to provide ad hoc message recipient lists

(75) Inventors: Jaakko Lehikoinen, Hameenkyro (FI); Jussi Severi Uusitalo, Hameenlinna (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/407,827

(22) Filed: Apr. 18, 2006

(51) Int. Cl. G06F 15/173

(52) U.S. Cl. 709/223

(57) ABSTRACT

A method includes initiating a message composition operation with a device; a user selecting a media as a message content; and the device automatically selecting at least one message recipient based at least in part on a type of media selected by the user.

### TECHNICAL FIELD

The teachings in accordance with the exemplary embodiments of this invention relate generally to user interfaces for devices and methods pertaining to same and, more specifically, relate to messaging applications for use in mobile and other types of devices.

### BACKGROUND

One technique for sending a message from a device is to send the message to a group of recipients. However, current stationary groups do not provide an efficient means for defining recipients in the messaging context. For example, if the message content defines the relevant recipients, then in accordance with conventional practice it is not possible to create such groups beforehand that could apply in different messaging contexts.

For example, assume that a user takes a picture of an art work with the camera of a cellular phone and wants to share it with friends who appreciate the same type of art. At present, the only available technique for defining the recipients is to manually select those recipients to whom the particular message, that includes the image as content, is to be sent.

### SUMMARY OF THE EXEMPLARY EMBODIMENTS

The foregoing and other problems are overcome, and other advantages are realized, in accordance with the non-limiting and exemplary embodiments of this invention.

In accordance with the exemplary embodiments of this invention there is provided a method that includes initiating a message composition operation with a device; a user selecting a media as a message content; and the device automatically selecting at least one message recipient based at least in part on a type of media selected by the user.

Further in accordance with the exemplary embodiments of this invention there is provided a computer program product that is embodied in at least one computer readable storage media and that comprises program instructions the execution of which by at least one data processor results in operations that include initiating a message composition operation with a device; a user selecting a media as a message content; and the device automatically selecting at least one message recipient based at least in part on a type of media selected by the user.

Still further in accordance with the exemplary embodiments of this invention there is provided a device that comprises at least one data processor; at least one memory coupled to the at least one data processor; at least one interface to a communications network that is coupled to the at least one data processor; and a user interface coupled to the at least one data processor. The data processor is responsive to a user selecting, via the user interface, a media from the memory during a message composition operation as a message content, to automatically select from the memory at least one message recipient based at least in part on a type of media selected by the user.

Further in accordance with the exemplary embodiments of this invention there is provided a data structure stored in a tangible memory device. The data structure includes a plurality of entries containing data for specifying message contact information for entities. The entries are organized by a plurality of message content types and, for each message content type, comprise contact information for an entity or entities that a message having that type of message content type was previously sent to. The data structure may further include, for each message content type, contact information for an entity or entities that a message having that type of message content type was previously received from. The data structure is searchable by a messaging application for automatically selecting at least one message recipient based on a subject of a message being composed.

### BRIEF DESCRIPTION OF THE DRAWINGS

The foregoing and other aspects of the exemplary embodiments of this invention are made more evident in the following Detailed Description, when read in conjunction with the attached Drawing Figures, wherein:

FIG. 1 is a simplified block diagram an embodiment of a wireless communications system having devices that are suitable for practicing the exemplary embodiments of this invention;

FIGS. 2 and 3 are useful in explaining the operation of the messaging application, and show certain components associated with the messaging application in block diagram form; and

FIG. 4 is a logic flow diagram that is illustrative of a method in accordance with the exemplary embodiments of this invention.

### DETAILED DESCRIPTION

By way of introduction, the use of the exemplary embodiments of this invention improve and enhance current approaches to providing a messaging capability for a user of a device, such as a mobile device (e.g., a cellular telephone) or a non-mobile device (e.g., a computer).

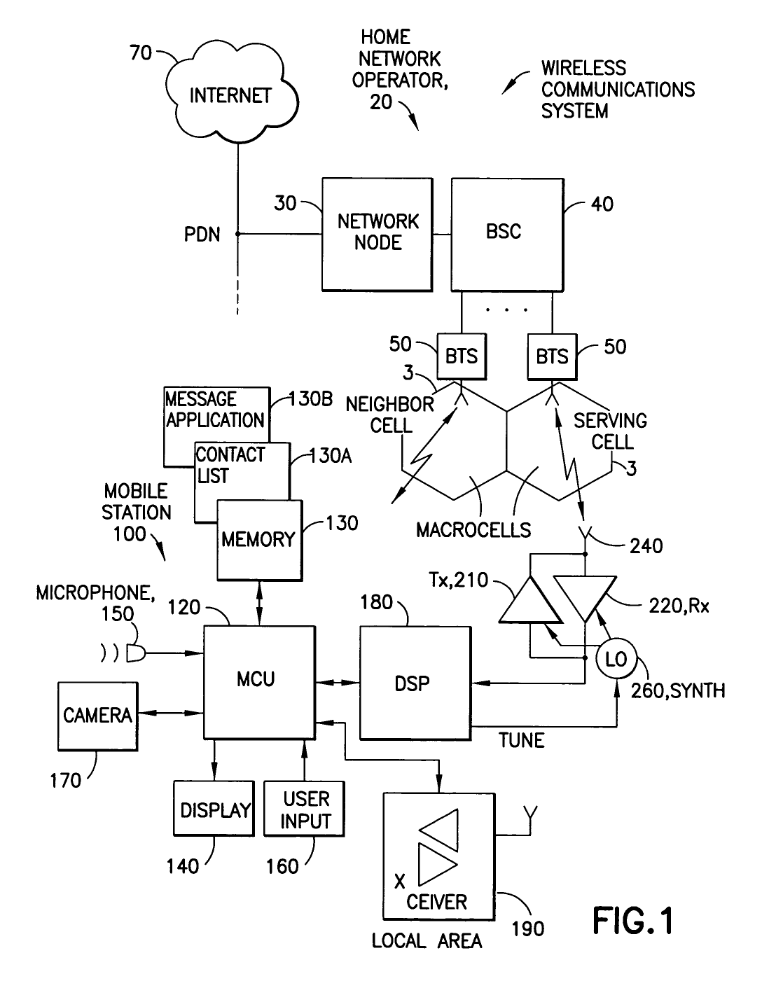

Referring first to FIG. 1, there is shown as a simplified block diagram a non-limiting embodiment of a device, such as a wireless communications device or mobile station 100, that is suitable for practicing the exemplary embodiments of this invention.

It should first be noted that while the exemplary embodiments of the invention will be shown and described as being practiced in a wireless communications terminal, in general the teachings of this invention apply to any type of electronic device that is capable of hosting a messaging application software. Thus, the exemplary embodiments of this invention may be used in desktop computers and workstations, laptop computers, notebook computers and personal digital assistants (PDAs), to name just a few of the many possible devices that can benefit from the use of the exemplary embodiments of this invention. As such, it should be appreciated that the description of the MS 100 in FIG. 1 is not intended to be read in any way as a limitation upon the use and possible implementations of the exemplary embodiments of this invention.

Still referring to FIG. 1, the mobile station 100 typically includes a control unit or control logic, such as a microcontrol unit (MCU) 120 having an output coupled to an input of a display 140 and an input coupled to an output of a user input 160, such as a real or virtual keyboard or keypad and that may include some type of pointing device such as, but not limited to, a stylus, a mouse or a touch-sensitive display screen. The mobile station 100 may be a handheld radiotelephone, such as a cellular telephone or a personal communicator. The mobile station 100 could also be contained within a card or module that is connected during use to another device. For example, the mobile station 10 could be contained within a PCMCIA or similar type of card or module that is installed during use within a portable data processor, such as a laptop or notebook computer.

In general, the various embodiments of the MS 100 can include, but are not limited to, cellular telephones, personal digital assistants (PDAs) and portable computers, and may include or incorporate, as non-limiting examples, image capture devices such as digital cameras, gaming devices, music storage and playback appliances, Internet appliances permitting Internet access and browsing, as well as units or terminals that incorporate combinations of such functions.

The MCU 120 is assumed to include or be coupled to some type of a memory 130, including a non-volatile memory for storing an operating program and other information, as well as a volatile memory for temporarily storing required data, scratchpad memory, received packet data, packet data to be transmitted, and the like. The operating program is assumed, for the purposes of this invention, to enable the MCU 120 to execute the software routines, layers and protocols required to implement the methods in accordance with the exemplary embodiments of this invention, as well as to provide a suitable user interface (UI), via display 140 and user input 160, with a user. A microphone 150 and a speaker (not shown) are typically provided for enabling the user to conduct voice calls in a conventional manner.

Stored in the memory 130 is assumed to be a data structure that is descriptive of a message contact list (CL) 130A, including records of messages sent from the MS 100, and possibly also messages received by the MS 100. Associated with the CL 130A is a message or messaging application 130B. The messaging application 130B comprises computer executable program code that interacts with the data structure that is descriptive of the CL 130A, the user interface comprised of the display 140 and the user input 160, as well as media stored in the memory 130, as will be described in detail below. The messaging application 130B that comprises computer executable program code is suitable for use in implementing the exemplary embodiments of this invention, as described more fully below.

The mobile station may also include an image capture device, such as a camera 170.

The mobile station 100 also contains a wireless section that includes a digital signal processor (DSP) 180, or equivalent high speed processor or logic, as well as a wireless transceiver that includes a transmitter 200 and a receiver 220, both of which are coupled to an antenna 240 for communication with the network operator. At least one local oscillator, such as a frequency synthesizer (SYNTH) 260, is provided for tuning the transceiver. Data, such as digitized voice and packet data, is transmitted and received through the antenna 240. The wireless section may be considered to function as a long range interface (e.g., hundreds or thousands of meters) to a base station coupled to a communications network, such as a cellular operator network and/or the Internet. Note that the MS 100 may also include a local area wireless transceiver (Xceiver) 190, such as one based on Bluetooth™ low power RF or infrared (IR) technology. The local area transceiver 190 may be considered as a short range interface (e.g., meters or tens of meters) for coupling to a wireless local area network (WLAN) via a suitable access point. Messages may be sent and received through either or both of the long and short range transceivers.

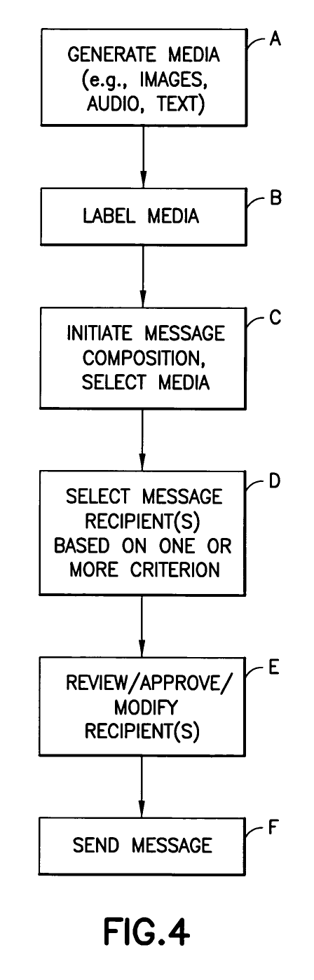

The exemplary embodiments of this invention may be implemented by computer software (e.g., the messaging application 130B) that is executable by a data processor of the mobile station 100, such as the processor 120, or by hardware, or by a combination of software and hardware. Further in this regard it should be noted that the various blocks of the logic flow diagram of, for example, FIG. 4 (described below) may represent program steps, or interconnected logic circuits, blocks and functions, or a combination of program steps and logic circuits, blocks and functions.

The memory 130 may be of any type suitable to the local technical environment and may be implemented using any suitable data storage technology, such as semiconductor-based memory devices, magnetic memory devices and systems, optical memory devices and systems, fixed memory and removable memory. The data processor(s) 120, 180 may be of any type suitable to the local technical environment, and may include one or more of general purpose computers, special purpose computers, microprocessors, digital signal processors (DSPs) and processors based on a multi-core processor architecture, as non-limiting examples.

The exemplary embodiments of this invention relate at least in part to (mobile) messaging and the creation of recipient groups.

The exemplary embodiments of this invention provide a mechanism to create a recipient group based on characteristics of message content in an ad hoc manner. As opposed to manually selecting the recipients or a group of recipients, the user instead may define the content of a message, and the messaging application 130B then analyses relationships between the definition of the content and contacts (such as contacts in the contact list, an address book, or a phone book, collectively referred to as the contact list 130A) and selects the relevant contact or contacts as the recipient(s) of the message.

As an example, assume a user locates an artwork for sale. The user finds the artwork attractive and photographs it using the camera 170. The user has friends who also like art and decides to send the image to them. The user invokes the messaging application 130B, and a blank message is displayed on the display 140. The image is used to insert the message body and the user writes “art” in the subject field. The messaging application 130B then searches for relations between the word “art” and contacts in the contact list 130A. Assume that the messaging application 130B finds five contacts who have shared similar type of content previously, and suggests these five contacts as message recipients. The user then has the option to accept the five selected contacts, or to remove one or more of them and/or to add another recipient (one not part of the original five contacts selected by the messaging application 130B).

There are a number of possible implementations for realizing the exemplary embodiments of this invention. For example, and with regard to the definition of contacts, they may be created automatically based on an interaction history, including messaging history and manual editing performed previously. The contact definition may also be performed manually by the user. The contact definition may also be accomplished by allowing the user to share a profile with one or more other users, where the profile includes metadata, such as user preferences, likes and dislikes, to aid the messaging application 130B to define relations between the content and users.

Further by example, and with regard to definition of content, this may be accomplished using, for example, an active subject field, a message body search, an analysis of relations between the content and contacts, and can be based on intelligence in creating new relationships and updating previous relationships between the content and contacts based on the user behavior, e.g., message characteristics used, actions performed for messages (forwarding certain kinds of messages for certain recipients) and personal folders created.

It can be appreciated that the exemplary embodiments of this invention enable and facilitate the definition of message recipients. The exemplary embodiments of this invention may also enable the user to remember certain contacts that have not been recently contacted, by generating the message recipient fields automatically for the user.

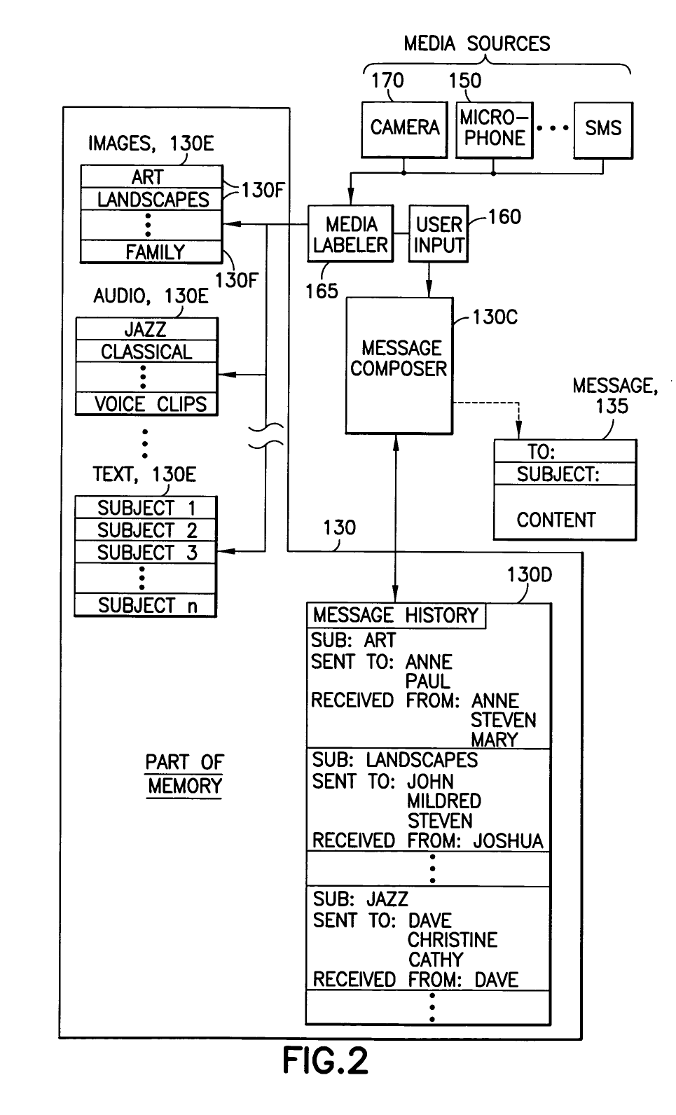

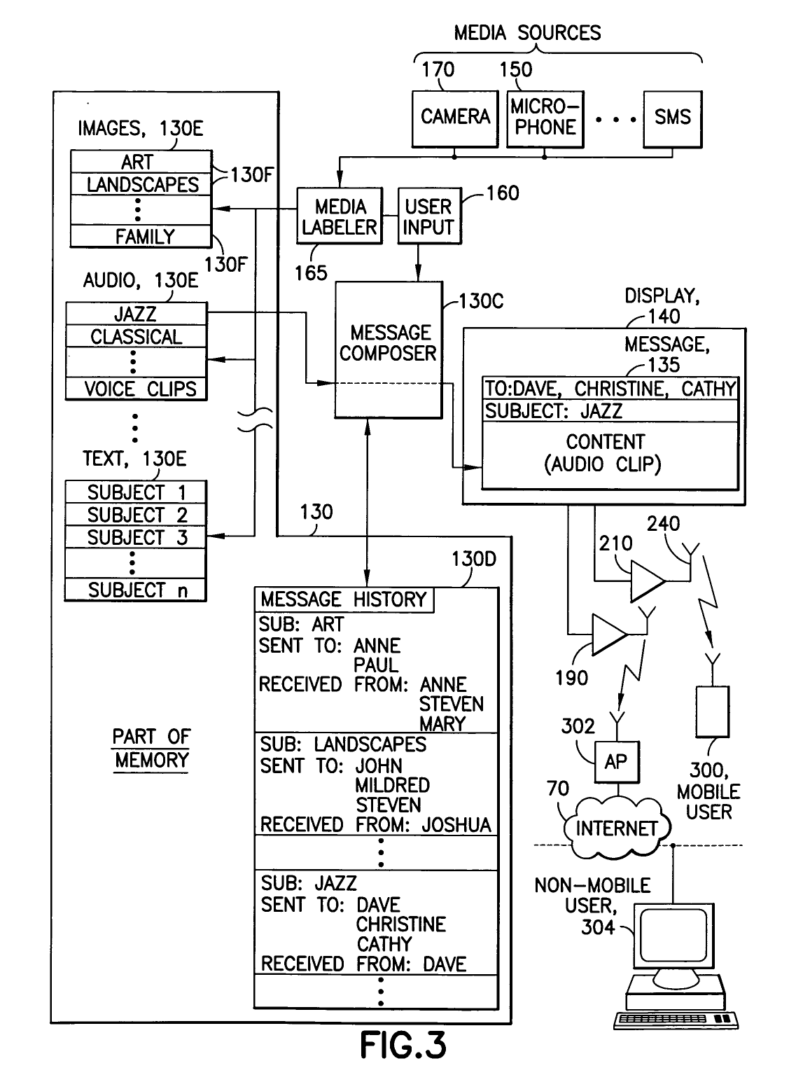

Reference is now made to FIGS. 2 and 3 for providing a further, more detailed description of the exemplary embodiments of this invention. The messaging application 130B includes a message composer 130C unit or sub-application that receives input from the user input 160, and that is bidirectionally coupled to a data structure 130D that is expressive of message history for the MS 100. In the non-limiting example the message history 130D is created and maintained by the messaging application 130B, and records certain information for messages sent from the MS 100, and optionally for messages that are received by the MS 100. Note that the message history data structure 130D may be a part of the contact list 130A, or it may be separate from the contact list 130A. In this non-limiting embodiment the message history 130D records for certain message subject types (e.g., category: images, sub-categories: “art”, “landscapes”, “family”; category: audio, sub-categories: “jazz”, “classical”, “voice clips”; category: text, and so forth) the names and other contact information (e.g., email address) for those recipients of the particular category/sub-category, and optionally the names and other contact information for senders of messages received by the MS 100 in these particular categories/sub-categories. Other, unillustrated information may be recorded as well, such as the date of the previously sent or received message as one non-limiting example, as well as a record of a number of such messages that were sent and/or received.

These categories preferably correspond to media stored in the memory 130, such as media stored in media folders 130E and sub-folders 130F. Associated therewith may be a media labeler module or function 165 that receives media from media sources (e.g., camera 170, microphone 150, SMS (text), and so forth). Note that text may be locally generated via the user input 160, such as when composing a document. The media labeler 165 is enabled to determine a general category based on the media source that generates the media, such as an image or a sound clip, or from other information, such as a file type. Alternatively, the category, and possibly sub-category, may be explicitly designated by the user via the user input 460. Alternatively, the labeler 165 may automatically designate the category based on the media source, e.g., “image”, while the sub-category is designated by the user (e.g., “landscape”), or as another example may designate the category as “audio” if the media source is the microphone 150, while the user designates the type of audio as “jazz” when recording a sound clip while at a concert. For media received from an external source (e.g., from the Internet 70) the labeler 165 may designate the category based on the file type (e.g., .jpg=image), while the user input 160 is employed to designate the sub-category, e.g., “mountain scene”. In any event, it may be assumed that the memory 130 is populated with one or more stored media from one or more media sources, and may possibly be logically arranged in the folders 130E and sub-folders 130F, as shown in FIG. 2. It may further be assumed that the user is enabled, via the message composer function 130C, to select and attach a certain media to a message 135 as all or part of the message content. In this case the user may then fill in the subject field with a descriptive text indicative of the media type of the message content.

Further in accordance with the exemplary embodiments of this invention, after the user selects and attaches a particular media to a message 135 as message content, the message composed 130C is enabled to access the message history 130D to lookup the associated contacts, based on at least one of the category and sub-category of the user-selected content. As is shown in FIG. 3 for the example media sub-category “jazz”, the message composer-130C automatically fills in the recipient field (To:) with the contact information for the corresponding “jazz” contacts in the message history data structure 130D. The resulting message is then displayed to the user on the display 140, enabling the user to approve or revise the list of recipients for the message 135, and possibly also approve or revise the subject line if filled in by the message composer 130C, via the user input 160. The message 135 can then be sent from the MS 100, such as by the long and/or short range interfaces, to the desired recipients, whether they be another mobile user 300 (possibly sent via a base station 40, 50 and network operator infrastructure as in FIG. 1), or via some access point (AP) 302 to another mobile or non-mobile user 304, such as via the Internet 70.

After sending the message the message composer 130C, or some other functionality, preferably updates the message history data structure 130D accordingly.

As was noted above, while the subject line may be filled in by the user, in some embodiments it could be filled in by the message composer 130C, depending on the media selected by the user and on the nature of any metadata associated with the selected media.

In the example illustrated in FIG. 3, and in accordance with exemplary embodiments of this invention, where the user has selected an audio clip previously labeled as “jazz” as the message content, the message composer 130C has automatically selected from the message history data structure 130D the recipients “Dave”, “Christine” and “Cathy” for the message 135. Note in this example that Dave has previously received a “jazz” message from the user, and has also previously sent the user a message having “jazz” in the subject line.

Referring to FIG. 4, and in accordance with the exemplary embodiments of this invention, at Block A media is generated by whatever means are desirable, such as by acquiring image data, or audio data, or text data, or receiving media from some external source, such as media downloaded from the Web. By whatever means the media is acquired it is labeled in some manner as to its semantic content (Block B). The labeling may be automatic based on, for example, the media source, or it may explicitly given. The media is assumed to be stored in some memory of the MS 100, even if only temporarily. At Block C the user initiates message composition with the messaging application 130B, and selects a media for the message content, At Block D, and in accordance with the exemplary embodiments of this invention, the messaging application 130B automatically selects at least one message recipient based on one or more criterion, such as by an analysis of the message history 130D to determine one or more parties who have previously received and/or sent a message having content of the same classification and/or sub-classification (e.g., the same “type” of content). At Block E, and based on the displayed message, the user is enabled to review and approve or modify the list of recipient generated by the messaging application 130B. At Block F the message is sent from the device, via one or both of the long range and short range interfaces.

Note that the execution of Block E may be considered to be optional.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof. Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting embodiments a full and informative description of the invention. However, various modifications and adaptations may become apparent to those skilled in the relevant arts in view of the foregoing description, when read in conjunction with the accompanying drawings and the appended claims.

For example, other type of media content may be employed than just the few examples discussed above. Further, it should be appreciated that in some devices that operate in accordance with the exemplary embodiments of this invention the interface or interfaces may be wired interfaces (e.g., cable, optical fiber) and not wireless interfaces per se.

Further by example, it should be noted that the automatic selection of recipient(s) is not limited only to persons as recipients. For example, assume a case of a user posting material, such as images, to his or someone else's blog. Here the recipient is a blog, as opposed to a person. Thus, as employed herein a recipient can be any entity, e.g., a person, or a real or virtual object or thing, having an address (such as, but not limited to, a phone number, an email address or a URL) where a message can be sent.

Still further by example, the information regarding the recipients can be constructed as well from sources other than messaging and communication history. For instance, the contacts might provide information regarding themselves. Further, a document, or a Powerpoint™, or other types of files can be analyzed for extracting contact-related information.

However, all such and similar modifications of the teachings of this invention will still fall within the scope of this invention.

Furthermore, some of the features of the examples of this invention may be used to advantage without the corresponding use of other features. As such, the foregoing description should be considered as merely illustrative of the principles, teachings, examples and exemplary embodiments of this invention, and not in limitation thereof.

What is claimed is:

1. A method, comprising:
initiating a message composition operation with a device;
a user selecting a media as a message content; and
the device automatically selecting at least one message recipient based at least in part on a type of media selected by the user.

2. The method of claim 1, where selecting a media further comprises specifying the type of media as a message subject in a message being composed.

3. The method of claim 1, where automatically selecting at least one message recipient further comprises specifying the type of media as a message subject in a message being composed.

4. The method of claim 1, further comprising sending the message via at least one device interface.

5. The method of claim 1, further comprising sending the message via at least one device wireless interface.

6. The method of claim 1, further comprising sending the message via at least one device wired interface.

7. The method of claim 1, where automatically selecting comprises examining a message history data structure to determine an identity of at least one entity as the message recipient based on a record of at least one previous message that was at least one of sent to or received from the entity, where the at least one previous message contained the same type of media as content.

8. The method of claim 2, where automatically selecting comprises examining a message history data structure to determine an identity of at least one entity as the message recipient based on a record of at least one previous message that was at least one of sent to or received from the entity, where the at least one previous message comprised a subject that matches the subject of the message being composed.

9. The method of claim 1, comprising initial steps of at least one of generating the media with the device or downloading the media into the device, and classifying the media as to media type.

10. The method of claim 1, further comprising the user modifying the at least one automatically selected message recipient.

11. A computer program product embodied in at least one computer readable storage media and comprising program instructions execution of which by at least one data processor results in operations comprising:
initiating a message composition operation with a device;
a user selecting a media as a message content; and
the device automatically selecting at least one message recipient based at least in part on a type of media selected by the user.

12. The computer program product of claim 11, where the operation of selecting a media further comprises specifying the type of media as a message subject in a message being composed.

13. The computer program product of claim 11, where the operation of automatically selecting at least one message recipient further comprises specifying the type of media as a message subject in a message being composed.

14. The computer program product of claim 11, further comprising an operation of sending the message via at least one device interface.

15. The computer program product of claim 11, further comprising an operation of sending the message via at least one device wireless interface.

16. The computer program product of claim 11, further comprising an operation of sending the message via at least one device wired interface.

17. The computer program product of claim 11, where the operation of automatically selecting comprises an operation of examining a message history data structure to determine an identity of at least one entity as the message recipient based on a record of at least one previous message that was at least one of sent to or received from the entity, where the at least one previous message contained the same type of media as content.

18. The computer program product of claim 12, where the operation of automatically selecting comprises an operation of examining a message history data structure to determine an identity of at least one entity as the message recipient based on a record of at least one previous message that was at least one of sent to or received from the entity, where the at least one previous message comprised a subject that matches the subject of the message being composed.

19. The computer program product of claim 11, comprising initial operations of at least one of generating the media with the device or downloading the media into the device, and classifying the media as to media type.

20. The computer program product of claim 11, further comprising an operation of the user modifying the at least one automatically selected message recipient.

21. A device, comprising:
at least one data processor;
at least one memory coupled to the at least one data processor;
at least one interface to a communications network that is coupled to the at least one data processor; and
a user interface coupled to the at least one data processor; where
the data processor is responsive to a user selecting, during a message composition operation, via said user interface a media from said memory as a message content, to automatically select from said memory at least one message recipient based at least in part on a type of media selected by the user.

22. The device of claim 21, where the user when selecting a media further specifies via said user interface the type of media as a message subject in the message being composed.

23. The device of claim 21, where the data processor the type of media as a message subject in the message being composed.

24. The device of claim 21, further comprising sending the message via said at least one interface.

25. The device of claim 24, where said at least one interface is comprised of one of a wireless interface and a wired interface.

26. The device of claim 21, where said data processor, when automatically selecting, examines a message history data structure stored in said memory to determine an identity of at least one entity as the message recipient based on a record of at least one previous message that was at least one of sent to or received from the entity, where the at least one previous message contained the same type of media as content.

27. The device of claim 22, where said data processor, when automatically selecting, examines a message history data structure to determine an identity of at least one entity as the message recipient based on a record of at least one previous message that was at least one of sent to or received from the entity, where the at least one previous message comprised a subject that matches the subject of the message being composed.

28. The device of claim 21, further comprising means for at least one of generating the media with the device or downloading the media into the device, and for classifying the media as to media type.

29. The device of claim 21, said data processor being responsive to the user interface for enabling the user to modify the at least one automatically selected message recipient.

30. The device of claim 21, embodied in a wireless communications unit.

31. The device of claim 21, embodied in a computer.

32. A data structure stored in a tangible memory device, said data structure comprising a plurality of entries containing data for specifying message contact information for entities, said entries organized by a plurality of message content types and, for each message content type, comprises contact information for an entity or entities that a message having that type of message content type was previously sent to.

33. The data structure as in claim 32, further comprising, for each message content type, contact information for an entity or entities that a message having that type of message content type was previously received from.

34. The data structure of claim 32, searchable by a messaging application for automatically selecting at least one message recipient based on a subject of a message being composed.

35. The data structure of claim 32, said memory device being coupled to a wireless communications unit.

36. The data structure of claim 32, said memory device being coupled to a computer.
